(19) United States
(12) Patent Application Publication
(10) Pub. No.: US 2005/0060747 A1
(43) Pub. Date: Mar. 17, 2005

(54) Business method for providing information services to consumers by means of a remotely-controlled, general-purpose computer

(76) Inventor: Gregory Alan Williams, Goffstown, NH (US)

Correspondence Address: Gregory A. Williams, 80 Shirley Hill Road, Goffstown, NH, 03045, US

(21) Appl. No.: 10/913,872

(22) Filed: Aug. 6, 2004

Related U.S. Application Data
(60) Provisional application No. 60/481,185, filed on Aug. 6, 2003.

(51) Int. Cl. H04N 7/173; G06F 13/00; H04N 5/445; G06F 3/00; G06F 17/60; G06F 9/44

(52) U.S. Cl. 725/60; 725/61; 705/26; 717/172; 717/173

(57) ABSTRACT

A business method in which information, software and services, including the decoding and presentation of consumer television programming, are delivered to consumers over a wide-area network—itself provided as part of the service—via a remotely-controlled, general-purpose computer which is also included in the service. The general-purpose character of the computer permits an ever-broadening array of information services to be marketed, sold and delivered, often without a house call. Remote control of the computer by the service provider shields the consumer from the administrative burden generally implied by intrinsically complex software and services. Once installed in the limited role of television decoder, the preconfigured general-purpose computer becomes a store through which a broad array of software and services can be marketed, sold and delivered to consumers.

### CROSS-REFERENCE TO RELATED APPLICATIONS

This application claims the benefit of provisional patent application Serial (APPL) NO. 60/481,185, filed on Aug. 6, 2003.

### BACKGROUND OF THE INVENTION

Consumer technology and content inexorably increase in their richness, but consumption of this richness is hindered by the concomitant complexity and the management burden richness implies. For example, consumers simultaneously love the richness of a personal computer, and the simplicity of a conventional analog phone. Likewise they decry the limitations of the phone, and the burden of managing the PC.

The following are examples of prior art that attempt to resolve this trade-off. Each of them is later described in sufficient detail to distinguish them from the invention.
Computer Management Services, such as iReady (http://www.irwservices.com)
Digital Video Recording Services, such as Tivo (http://www.tivo.com)
Set-Top Computer Services, such as Microsoft MSN TV (http://messenger.msn.com/Devices/MsftTV.aspx)
Television Services, such as over-the-air Broadcast, Satellite and Cable, such as Comcast (http://www.comcast.com)
Smart Device Wireless Telephones, such as Microsoft Smart Phones (http://www.microsoft.com/windowsmobile/smartphone/default.mspx)
Multimedia PC's, such as Those Running Windows XP Media Center Edition (http://www.microsoft.com/windowsxp/mediacenter/default.mspx)

In addition, the following U.S. patents will be described in sufficient detail to distinguish them from the invention.
U.S. Pat. No. 5,613,089 Method and apparatus for remotely controlling and monitoring the use of computer software
U.S. Pat. No. 5,944,608 Computer software delivery system
U.S. Pat. No. 6,202,207 Method and a mechanism for synchronized updating of interoperating software
U.S. Pat. No. 6,259,442 Downloading software from a server to a client
U.S. Pat. No. 6,360,253 Split personal computer system
U.S. Pat. No. 6,489,979 Non-computer interface to a database and digital library
U.S. Pat. No. 6,618,858 Automatic identification of a set-top box user to a network
U.S. Pat. No. 6,628,340 Multipurpose computerized television
   Computer Management Services such as iReady

There are a wide variety of computer management services which can remotely control and configure general-purpose computers. These services address management issues comprising the following:
Shipping or direct installation of hardware.
Remote installation of application, driver and operating system software, including patches.
Configuration of software and hardware to render computers reliable, suitable and secure, either remotely or in-person.
Assistance to end-users in forms comprising online chat, call centers and knowledge bases.
Selling, renting or otherwise providing software to the end-user without requiring separate arrangements between parties other than the service provider and the customer.

These services do not also provide access to consumer television content, and do not include the provisioning or management of the network connection to the service provider.

Digital Video Recording Services such as Tivo

Digital video recording services, which are often bundled with cable or satellite television services do often use hardware and other technology used by PC's and other general-purpose computers, however, they do not sell, rent, run or otherwise provide access to commercial software to the end-user.

Set-Top Computer Services such as Microsoft MSN TV

There exist a number of services which provide set-top devices that afford access to PC-like services, such as web-browsing, e-mail, text processing and viewing of photographs. These services lack the following features of the invention:
They do not sell, rent, run or otherwise provide access to commercial software to the end-user.
While they may use the same television screen used to view consumer television content, these services do not provide consumer television content themselves.
   Television Services such as Over-the-Air Broadcast, Satellite and Cable

Consumer television services including over-the-air broadcast stations, cable companies and satellite companies currently deliver consumer television content. Some also provide services and equipment necessary for video recording or “on-demand” services allowing end-users to play content at times of their choosing. Some also support the use of general-purpose computers to view content and pay bills. These services lack the following features of the invention:
They do not provide a pre-configured general-purpose computer.
They do not sell, rent, run or otherwise provide access to commercial software to the end-user.
   Smart Device Wireless Telephones such as Microsoft Smart Phones

Wireless telephone services currently offer a wide variety of content and services. In particular, services offering “Smart Phones” or “Smart Devices” include some or all of the following features:
Recorded, low-resolution video content.
Photographs.
Live and recorded audio content.
Game software.
Utility software, such as calculators.
User-installable, commercially-available software, such as Pocket Office.
Remote management of the operating system of the device (phone handset.)
Communicating information with a remote devices via Internet Protocol or similar protocol over the network provided by the service provider.

These services differ from the invention in the following ways:
None of these devices uses a general-purpose operating system, capable of running commercially-available PC software. They run special-purpose operating systems such as PalmOS and Windows CE, which are not capable of supporting commercially-available PC software.
They do not control the user's ability to install software on his/her own, or permit the service provider to charge for such use.
They do not include the ability to deliver or the delivery of broadcast-quality video.
   Multimedia PC's such as Those Running Windows XP Media Center Edition

There are many general-purpose computers available for sale that are capable of all of the functions required by the invention, including:
Decoding and playback of broadcast-quality video content.
Receiving of consumer television content.
Capability of running commercially-available PC application software.
Communicating information with a remote devices via Internet Protocol or similar protocol over the network.

These PC's differ from the invention in the following ways:
They are products, not services.
They are not purchased from the same entity providing the network.
They permit the installation of additional software and hardware without the knowledge or help of the original seller, nor the opportunity for the seller to charge the user.
   U.S. Pat. No. 5,613,089 Method and Apparatus for Remotely Controlling and Monitoring the Use of Computer Software

This patent covers methods that might be used by the invention to manage the general-purpose computer, but is different in the following ways:
While it is a method, it does not present a business method for collecting revenue.
It covers the management of application software but not content such as video, audio, text or graphics.
   U.S. Pat. No. 5,944,608 Computer Software Delivery System

This patent covers methods that might be used by the invention to manage the general-purpose computer, but is different in the following ways:
While it is a method, it does not present a business method for collecting revenue.
It covers the management of application software but not content such as video, audio, text or graphics.
   U.S. Pat. No. 6,202,207 Method and a Mechanism for Synchronized Updating of Interoperating Software

This patent covers methods that might be used by the invention to manage the general-purpose computer, but is different in the following ways:
While it is a method, it does not present a business method for collecting revenue.
It covers the management of application software but not content such as video, audio, text or graphics.
   U.S. Pat. No. 6,259,442 Downloading Software from a Server to a Client

This patent covers methods that might be used by the invention to manage the general-purpose computer, but is different in the following ways:
While it is a method, it does not present a business method for collecting revenue.
It covers the management of application software but not content such as video, audio, text or graphics.
   U.S. Pat. No. 6,360,253 Split Personal Computer System

This patent describes a different means of managing an end-user's access to technology and content. It differs from the invention in the following ways:
It is a device, not a service.
It achieves control by removing the computer from the user's location, leaving the user with only a display system at his/her location. The invention delivers service by locating a general-purpose computer at the end-user's location.
   U.S. Pat. No. 6,489,979 Non-Computer Interface to a Database and Digital Library

This patent describes a different means of managing an end-user's access to content. It differs from the invention in the following ways:
It is a device, not a service.
It achieves control by explicitly giving the user a “non-computer intervace”. The invention delivers service by locating a general-purpose computer at the end-user's location.
   U.S. Pat. No. 6,618,858 Automatic Identification of a Set-Top Box User to a Network

This invention describes a means of providing a small subset of the functionality of the invention; that of identifying a device to the network. Indeed, the invention uses general-purpose computers as delivery devices because they afford the use of general-purpose operating systems which themselves support many different means of identifying both individual users and the computers themselves.

U.S. Pat. No. 6,628,340 Multipurpose Computerized Television

This patent describes a device which might qualify as the “general-purpose computer” specified by the invention. It does not describe any of the remaining aspects of the primary claim.

### BRIEF SUMMARY OF THE INVENTION

The invention provides a business method for providing all of the advantages of the previously described art while dramatically decreasing the management complexity experienced by the end-user. Specifically, the method calls for a service provider to use a general-purpose computer as the “box”, “decoder” or “controller” for delivering consumer television content. Once installed in this limited role, that computer can be used to market, sell and deliver an ever-expanding variety of additional content, services, software and hardware.

### DETAILED DESCRIPTION OF THE INVENTION

Definition of Terms

Broadcast-Quality Video

Broadcast-quality video is video content and delivery that complies with or exceeds the quality of widely-used video broadcast standards comprising NTSC, PAL and SECAM.

General-Purpose Computer

The key attribute here is that the manufacturer of a general-purpose computer does not know the purpose for which the computer will be used. The design objective is comprehensive flexibility, not performance of a defined task. The relevance of the label “general-purpose” in the context of this specification is the ability to perform the widest array of functions enabled by the technology. Examples of general-purpose computers are PCs, mainframes and workstations.

General-Purpose Operating System

As with “general purpose” hardware, the design objective of a general-purpose operating system is to provide access to all the potential utility of a microprocessor instruction set. Examples of general-purpose operating systems are Windows XP and unix. Illustrating the intended distinction from the nonqualifying side is the operating system Windows CE intended for exploitation of consumer-electronic devices. The design objective of a general-purpose operating is the same as that for a general-purpose computer, namely the ability to perform the widest possible array of functions possible.

Consumer Television

Again, as with the definition of general-purpose computer and general-purpose operating system, the label “consumer” conveys comprehensive flexibility that includes traditional business programming, such as training, and entertainment programming, such as soap operas.

Remote Administration

The critical issue here is retention of so-called root privilege by the service provider. That is, ultimate control over the configuration of the general-purpose computer is retained by the service provider. This control is critical to the standardization that makes the operation of the general-purpose computer reliable and its administration cost-effective.

High-Quality Authentication

High quality authentication implies the ability to present information confirming a user's unique identity without allowing that information to be captured by a third party and later used fraudulently.

Complex Application Software

Software, such as Microsoft Office, requiring a general-purpose operating system.

Non-TV Appliance

A non-TV appliance is any household appliance, such as a personal computer, printer, washing machine or healthcare-related measuring device (blood pressure or blood sugar monitors, e.g.) other than a device used to display decoded television signals.

User-Preference Data

User-preference data comprises web sites visited, settings in software applications, such as Microsoft Office, television programs watched. Such data should be used with the permission of the user.

Housecall

A housecall is work performed by an employee of the service provider at the physical location of the consumer. The invention minimizes the requirement for housecalls, which are notoriously expensive.

### PREFERRED EMBODIMENT

The preferred embodiment comprises a cable-TV provider, such as Charter or Comcast, partnering with hardware and software providers to offer a standardized hardware-software configuration capable of decoding and presenting conventional (NTSC, e.g.) TV programming, and also capable of offering a broad range of additional software and services with few, if any, “house-calls” to the consumer's location. Additional services will grow over time to include telephony, the management of a variety of household appliances, including PCs and printers, as well as healthcare appliances, such as blood-sugar and blood-pressure monitors. Standardization of the hardware, software and configuration, and the control required to maintain such standardization, minimizes the cost and complexity of administration while maximizing the availability (“up time”) of the system. Standardization over a large customer set, such as cable customers, allows attractive economies of scale.

1. A business method, comprising:
delivering information, software and services to consumers by means of a general-purpose computer,
wherein said general-purpose computer is equipped and configured for communication with remote devices over a wide-area network,
wherein access to said wide-area network is provided as part of said service,
wherein said communication is used for remote administration of said general-purpose computer,
wherein said general-purpose computer is capable of running commercially-available complex application software,
wherein said information services include the decoding and presentation of consumer television content.

2. The business method of claim 1 wherein the primary display device for said general-purpose computer is a television owned by the consumer.

3. The business method of claim 1 wherein the primary control device for said general-purpose computer is a hand-held remote control device.

4. The business method of claim 1 wherein control of said general-purpose computer exercised by a wireless and/or wired keyboard and/or mouse.

5. The business method of claim 1
wherein the general-purpose computer is equipped and configured for said remote administration prior to delivery to said consumer.

6. The business method of claim 1
wherein said wide-area network comprises the internet.

7. The business method of claim 1
wherein a supplier of said software and services is, or partners with, a cable-television provider.

8. The business method of claim 1
wherein a supplier of said software and services is, or partners with, a satellite-television provider.

9. The business method of claim 1
wherein a service provider controls access to and facilitates the delivery of, and billing for, said software and services.

10. The business method of claim 1
wherein said information services comprise telephony.

11. The business method of claim 7
wherein said telephony is packet-based.

12. The business method of claim 1,
wherein said information services comprise videoconferencing.

13. The business method of claim 1,
wherein said information services comprise authentication.

14. The business method of claim 10,
wherein said information services comprise remote access by user to information stored on said general-purpose computer

15. The business method of claim 1,
wherein said information services comprise communication with a non-TV appliance.

16. The business method of claim 12,
wherein said communication utilizes a wireless local-area network (LAN)

17. The business method of claim 12,
wherein said non-TV appliances is a printer.

18. The business method of claim 12,
wherein said non-TV appliance is a healthcare-related data-collection device.

19. The business method of claim 12,
wherein said household appliance is a personal computer

20. The business method of claim 1,
wherein user-preference data is used to personalize marketing,

21. The business method of claim 1,
wherein user data such as documents, photographs and music files are stored locally on the said general-purpose computer,

22. The business method of claim 1,
wherein user data such as documents, photographs and music files are stored locally on the said general-purpose computer and backed-up to a central location

23. The business method of claim 1,
wherein additional services are delivered through hardware devices that are pre-configured by and delivered by retail partners using configuration specifications agreed to or provided the service provider.
